(19) United States
(12) Patent Application Publication
(10) Pub. No.: US 2010/0193066 A1
(43) Pub. Date: Aug. 5, 2010

(54) Livestock Water Bowl

(76) Inventor: Andrew Kenny, Beachburg (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 12/223,266

(22) PCT Filed: Jan. 25, 2007
(86) PCT No.: PCT/CA2007/000093

§ 371 Date: Jul. 25, 2008

Related U.S. Application Data
(60) Provisional application No. 60/762,129, filed on Jan. 26, 2006.

(51) Int. Cl. B65B 1/04; A01K 7/06

(52) U.S. Cl. 141/1; 119/75

(57) ABSTRACT

A water vessel for providing water to livestock animals in tie stalls is described. The vessel features a sensor for providing water in response to a sensed presence of a livestock animal's head within the vessel. As water is provided to the vessel, the livestock animal is compelled to lift their head and thereby withdrawing their head from the region sensed by the sensor. In this way, the depth of water in the vessel is maintained within a predetermined range. The vessel also comprises a rim that is disposed sufficiently above the predetermined range of water levels that the livestock animal is compelled to lift their head in a substantially vertical fashion in order to withdraw their head from the vessel. This serves to reduce the spillage of water from the vessel.

### FIELD OF THE INVENTION

The invention relates to a system for providing water to livestock without wasting water. More specifically, the invention relates to a water bowl for providing water to cattle that serves to reduce water being splashed from the bowl.

### BACKGROUND

Dairy farming represents a way of life for many farmers around the world. Many dairy farms rely on keeping cows in a tie stall for extended periods of time. In order to provide large volumes of quality milk it is commonly accepted practice to provide as much drinking water as the cow chooses to drink. In addition, the stall has feed and bedding material for the cow.

A typical design for a water bowl used in dairy farming comprises a bowl for holding water, water supply line and a valve. The valve supplies water from the water supply line to the bowl in response to a movement of the valve. Common designs for valves provide water when the valve is nudged by the muzzle of the cow. Thus, the cow is able to activate the valve and thereby provide water to the bowl as desired by the cow. Such a design is provided by Li et al. in U.S. Pat. No. 6,332,428. Typically, when the cow is drinking water from the bowl, the valve is not engaged and water flow stops. This problem has been addressed by others as well. For example, Anderson describes an alternative water bowl for cattle in U.S. Pat. No. 2,260,817. Mitchell teaches another design in U.S. Pat. No. 1,365,934 and Blough teaches a design in U.S. Pat. No. 3,144,853.

One problem that existing water bowls do not address is that cows often splash water out of their bowls. Thus, the floor near the water bowl is often wet. It is often the case that the feed material is provided near the water bowl. If the feed material gets wet it will become spoiled and the cow will be far less likely to eat it. This results in added costs due to wasted feed in addition to the effort made to remove the spoiled feed. In addition, the presence of water on the floor also results in other costs to the farmer. For example, when the stall is made of wood, the wood is more prone to rotting when it is wet.

In some cases, playful cows will actively put water in their bowl just to splash it out. Clearly, the water wasted from the feeding bowl of a cow results in added costs to a farmer due to spoiled feed. Also it is apparent that the cost of providing milk would rise dramatically if the tie stall were large enough that the cow could not splash water from the bowl to the feed. Thus, this solution to the problem is not practical.

While issues associated with providing water to dairy cows in tie stalls are described it will be apparent to one of skill in the art that analogous problems exist for providing water to other livestock. For example, horse farms may also benefit from a waterbowl that would keep a horse's stall or pen drier and reduce bedding and labour requirements.

It would be beneficial to provide a water bowl that a dairy cow is able to drink from yet inhibits the cow from splashing water out of the bowl. Further, it would be beneficial to provide such a water bowl without incurring very high costs or substantially reducing the functionality of the water bowl.

### SUMMARY OF THE INVENTION

Embodiments of the invention teach an apparatus for providing water to a livestock animal, comprising: a vessel for retaining water, the vessel having an opening with a rim; a valve biased to a closed position for substantially preventing the flow of water into the vessel from a water supply line, the valve operable between the closed position and an open position for controllably dispensing water into the vessel from the water supply line; and, a sensor in communication with the valve for actuating the valve between the biased closed position and the open position in response to a sensed presence of the muzzle of the livestock animal within a predetermined sensing region, the sensing region disposed within the vessel at a depth below the rim that is selected such that the livestock animal is stimulated to withdraw its muzzle away from the sensing region in response to rising water level approaching a predetermined maximum water level in the vessel.

In accordance with embodiments of the invention there is a provided a method for providing water to a livestock animal, comprising: providing a vessel for receiving water from a water supply via a flow valve; sensing the presence of the muzzle of the livestock animal in a sensing region within the vessel, the sensing region corresponding to a predetermined region within the vessel that is below a maximum fill level of the vessel; and, supplying water from the water source into the vessel via the flow valve when the presence of the muzzle of the livestock animal is sensed within the sensing region,

wherein the location of the sensing region is selected such that the animal is stimulated to move its muzzle from a sensed condition to a non-sensed condition in response to rising water level approaching the maximum fill level of the vessel.

Further, embodiments of the invention support a method for providing water to a livestock animal, comprising: providing a water source for supplying water to a vessel via a flow valve; defining a maximum fill level of the vessel; disposing a sensor within the vessel at a predetermined depth below the maximum fill level of the vessel for controllably actuating the flow valve between a biased closed position absent a muzzle being sensed within the vessel and an open position when a muzzle is sensed within the vessel, the predetermined depth being selected such that the animal is stimulated to move its muzzle away from the sensor in response to rising water level approaching the maximum fill level of the vessel.

### BRIEF DESCRIPTION OF THE DRAWINGS

Exemplary embodiments of the invention will now be described in conjunction with the following drawings, in which similar reference numerals designate similar items:

FIG. 1 is a diagram of a first prior art water bowl for feeding livestock;

FIG. 2 is a diagram of a second prior art water bowl with a high rim;

FIG. 3a is a cross section diagram of a water bowl according to a first embodiment of the invention;

FIG. 3b is a top view of deformed flexible bowl installed such that it is useable by cows in adjacent stalls; and,

FIG. 4 is a cross section diagram of a second embodiment of the invention featuring a valve and a sensor.

### DESCRIPTION OF EMBODIMENTS OF THE INVENTION

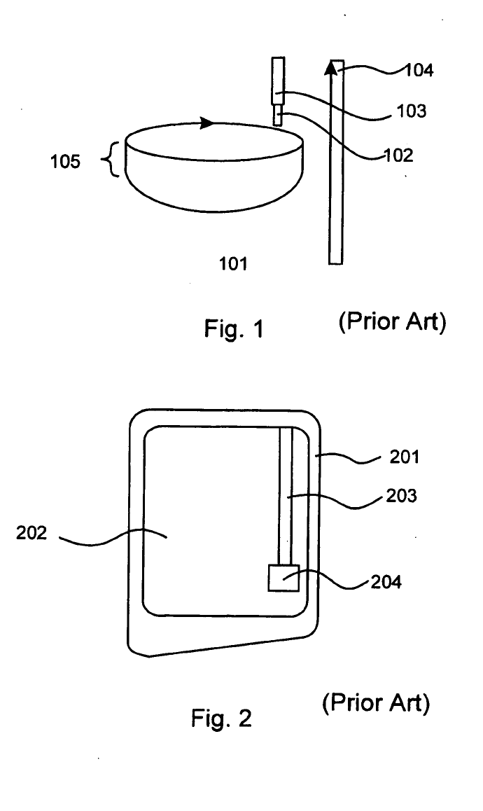

Referring to FIG. 1, a diagram of a prior art water bowl is shown. The prior art water bowl comprises: a bowl 101 and a valve 102. Such a prior art bowl is typically attached to a vertical structural member 104 using a bracket (not shown). The valve 102 is connected to a water supply line 103 such that when the valve is suitably activated, water from the water supply line 103 is provided to the bowl 101. Such a valve 102 is described in further detail in U.S. Pat. No. 4,561,633 by Haiges. Typically, the valve 102 is designed to provide water in response to a movement of the valve associated with a cow pushing against the valve with its muzzle. The bowl 101 comprises a raised rim 105 that is intended to reduce the amount of water that splashes out of the bowl. Unfortunately, the design of the rim 105 is insufficient for this purpose and, as a result, a cow is easily able to spill water from the bowl.

A variety of prior art bowl designs exist. Some of these bowls'are specifically designed to reduce the wasting of water. Referring to FIG. 2, an alternative design for a water bowl is shown in accordance with U.S. Pat. No. 6,000,363 by Rader. The bowl design proposed by Rader comprises a container 201 with an opening 202 that the cow puts their muzzle in. A water supply line 203 provides water to a valve 204 consistent with the valve of Haiges. The bowl of Rader is designed such that when water is provided to the bowl, the water pools within the bowl at a location that is somewhat remote from the valve that is used to supply the water. Thus, according to Rader, a cow using the container 201 has the choice of actuating the valve 204 or drinking water within the container 201 but is unable to do both simultaneously. A person of skill in the art will appreciate that a cow drinking from such a system still has the opportunity to splash some water out and water on the muzzle of the animal will drip when the animal removes its muzzle from the bowl. A water bowl system provided by Li et al. in U.S. Pat. No. 6,332,428 also features a bowl with a low rim.

A person of skill in the art will appreciate that a wide variety of different water bowls for cattle exist. While the geometries of the various bowls are all different they are all accessible from a low rim. There are three main ways in which water is typically spilled from a water bowl by a cow. The water is splashed by motion of the muzzle of the cow in water. The cow fills up the bowl and places its muzzle in the bowl resulting in the water being displaced over the rim of the bowl. In addition, cows can play with the water while their muzzle is in the water bowl. All of these methods of wasting water are facilitated by the presence of the low rim.

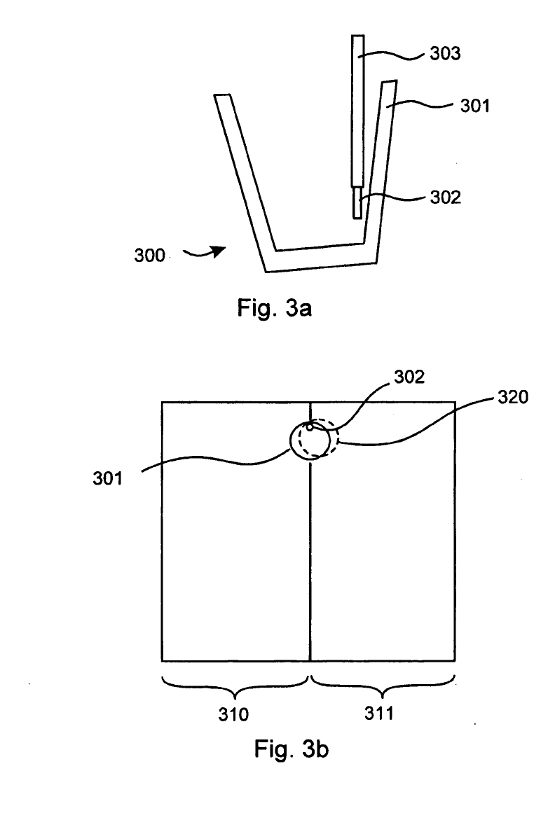

Referring to FIG. 3a, a water system 300 according to a first embodiment of the invention is shown. The water system 300 comprises: a bowl 301, and a valve 302. The water system 300 provides water to the bowl 301 via a water supply line 303. When a cow actuates the valve 302, water is provided to the bowl 301. An external structural member (not shown) supports the bowl 301. Unlike the prior art designs for water bowls, the bowl 301 according to the first embodiment of the invention is sufficiently deep that a cow drinking from the bowl 301 is compelled to lift its head up substantially to remove it's muzzle from the bowl. By lifting its head up, the cow has far less water dripping from its muzzle once its head has been removed from the bowl. Clearly, providing walls to the bowl that are substantially vertical inhibits a cow from lifting its head along a sideways trajectory as would occur when the cow tries to splash water out of a bowl. Further, if the cow should attempt to splash water out of the bowl 301, the water is far less likely to escape from the bowl 301 due to the height of the rim relative to the normal level of the water. In addition, excess water in the mouth of the cow is likely to fall downward into the bowl instead of being expelled outside the bowl. In addition, the depth of the bowl makes it far more difficult for the cow to displace sufficient water from the bowl to spill the water.

The bowl 301 is sufficiently deep that the cow would have to put a significant portion of its muzzle, specifically their nostrils, underwater in order to actuate the valve 302 to completely fill the bowl 301. This prevents the cow from breathing. As this is not something that cows typically do, the level of the water typically remains quite low relative to the top of the rim of the bowl 301. In particular, the water level in the bowl 301 typically remains at or below a level at which the cow is able to actuate the valve whilst keeping its nostrils just above the water line. Clearly, this is not the case when the bowl 301 is nearly filled with water, since the valve 302 is then at a depth below the water line that requires the cow to submerse its nostrils in the water in order to actuate the valve 302. A person of skill in the art will appreciate that a cow is able to easily drink from the bowl 301 when the water in the bowl is, for example, only 2 inches (5 centimetres) deep. It is suggested that the rim of the bowl be approximately 10 inches (25 centimetres) above the desired water level (i.e. total wall height of 12 inches or 30 cm). This serves to inhibit spilling water from the bowl. A person of skill in the art of moulding plastics will appreciate that it is beneficial to design the bowl such that for a bowl shaped as a revolution of a surface about a central axis, the radius of the bowl increases to a maximum value at the rim, where the increase in radius is minimized yet greater than zero. Thus, for example, an angle of 2 to 15 degrees from the axis of revolution is considered desirable for the geometry of the bowl. This gives the bowl a truncated cone shape. Clearly, the angle chosen should be determined in dependence upon the chosen manufacturing process as will be well understood by one of skill in the art of moulding. Larger angles are still likely to provide practical benefits as described with reference to embodiments of the invention.

A person of skill in the art will appreciate that the water system 300 is easily mounted using a water supply line and a structural member consistent with those same components used in prior art water bowls. Thus, an existing tie stall for cattle is easily retrofitted to support the water system according to the invention. It is suggested that valve 302 be positioned sufficiently low within the bowl 301 that a cow is unlikely to raise the water level near the rim of the bowl by pressing on the valve for an extended period of time. Again, the cow is decreasingly likely to activate the valve 302 as the depth of the valve 302 below the water line in the bowl increases. A person of skill in the art will appreciate that there are a wide variety of water sensors available.

In order to avoid injury to a cow from hitting or rubbing against the water system according to the invention, it is suggested that the bowl 301 be made from a strong, flexible material. A person of skill in the art will appreciate that a variety of rubber and plastic materials are optionally used. In addition, it is suggested that a plate be provided for supporting a secure structural link to whatever outside structural member is used for mounting the water bowl. Ideally, the water system maintains the valve 302 at an approximately fixed location relative to the rim of bowl 301. In addition, it is desirable to limit the range of motion of the valve 302 such that when the valve 302 is pushed in a forceful manner the motion of the valve 302 is limited, thereby protecting the valve 302 from damage. A person of skill in the art will appreciate that there are a variety of ways of mounting the bowl 301 to achieve this result.

Referring to FIG. 3b, a top view of a bowl 301 is shown disposed such that a cow in a first stall 310 and a cow in a second stall 311 are both able to access the bowl 301 and the valve 302. Due to the flexibility of the bowl 301, a cow is easily able to deform the bowl in order to gain easier access to the water in the bowl 301. Thus, when a cow in stall 311 accesses the bowl 301 the cow optionally deforms the bowl 301 to a second shape shown by dashed line 320. In this way, a same bowl and sensor are used to service cows in more than one stall. This serves to reduce the number of bowls used and thereby reduce costs. Clearly, while the bowl supports deformation in the sideways direction it remains structurally robust in the vertical direction such that bowl inhibits the wasting of water by, for example splashing.

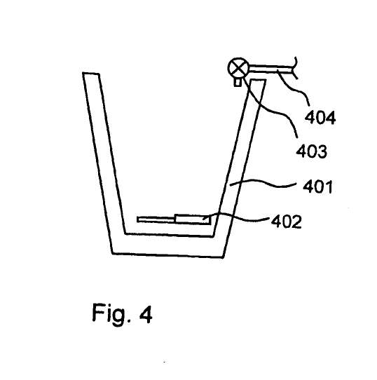

Referring to FIG. 4, a cross section view of a second embodiment of the invention is shown comprising: a vessel 401, a sensor 402, a valve 403 and, a water supply line 404. The second embodiment of the invention provides water to the vessel 401 in response to an animal coming in close proximity to the sensor 402. Specifically, when the sensor 402 senses the presence of the animal, the sensor 402 provides a signal to the valve 403. The valve 403, being responsive to the signal, allows water to flow from the water supply line 404 into the vessel 401. When the sensor does not sense the presence of an animal it does not provide the signal and the valve 403 acts to inhibit the flow of water to the vessel 401. Thus, when the muzzle of the animal is provided in the vessel 401, water is provided. When the water rises, the animal lifts its muzzle and drinks. Clearly, the second embodiment of the invention is best configured such that the sensor 402 only provides the signal when the muzzle of the animal is well within the vessel 401 and well below the rim of the vessel 401. In this way, the system according to the second embodiment of the invention acts to maintain a level of water well below the lowest location from which water is able to spill from the vessel. Optionally, the sensor comprises a water level sensor. When the level of the water within the vessel reaches a predetermined threshold, additional water from the water supply line 404 is inhibited from entering the vessel 401. In this way, it is a simple matter to ensure that the level of the normal water level remains well below that of the rim of the vessel 401. This serves to inhibit splashing of the water out of the vessel.

A person of skill in the art will appreciate that a water bowl designed in accordance with the embodiments of the invention provides a variety of benefits to farmers. For example, the bowl itself is not complex and consequently, it may be produced inexpensively without sacrificing quality or functionality. It is well understood that dairy cows are often reluctant to consume wet feed. This has the consequence of reducing the amount of milk the cows produce. By inhibiting the splashing of water and other forms of water waste, the feed and the area near the cow are kept dry and this provides a variety of benefits. For example, a farmer may reduce their time and costs associated with replacing feed and bedding material for the cow. Since the feed is kept dry, the cow is less likely to go off the feed. Additionally, wet conditions in the stall are known to lead to certain health conditions in dairy cattle, such as soft hooves and ulcers. In addition, the geometry of the bowl beneficially makes it less likely that feed will be brought into the bowl thereby reducing the need to clean the bowl. Thus, the water bowls described with reference to the embodiments of the invention offer benefits that lead to improved milk production for the cows and enhanced productivity for the dairy farmer.

Numerous other embodiments of the invention will be apparent to one of skill in the art without departing from the spirit and scope of the invention. For example, while embodiments of the invention described focus on dairy cattle, a person of skill in the art will appreciate that other livestock, such as horses, are optionally provided water from bowls designed in accordance with the teachings of the invention. A flexible bowl, as described with reference to FIG. 3b, would less likely to sustain damage or injure a horse that is running around a pen.

1. An apparatus for providing water to a livestock animal, comprising:
a vessel for retaining water, the vessel having an opening with a rim;
a valve biased to a closed position for substantially preventing the flow of water into the vessel from a water supply line, the valve operable between the closed position and an open position for controllably dispensing water into the vessel from the water supply line; and,
a sensor in communication with the valve for actuating the valve between the biased closed position and the open position in response to a sensed presence of the muzzle of the livestock animal within a predetermined sensing region, the sensing region disposed within the vessel at a depth below the rim that is selected such that the livestock animal is stimulated to withdraw its muzzle away from the sensing region in response to rising water level approaching a predetermined maximum water level in the vessel,
wherein the vessel is shaped for guiding the livestock animal to advance its muzzle into the predetermined sensing region when the water level is below the predetermined maximum water level.

2. An apparatus according to claim 1 wherein the vessel comprises at least a sidewall and the at least a sidewall is approximately perpendicular to a base of the vessel.

3. An apparatus according to claim 1 wherein the valve and the sensor are provided as a same component.

4. An apparatus according to claim 3 wherein the valve is for providing water when the sensor is in physical contact with the animal.

5. An apparatus according to claim 1 wherein the sensor is disposed at least 10 inches (25 cm) from the rim of the vessel.

6. An apparatus according to claim 5 wherein the sensor is disposed such that when the opening is facing upward and there is two inches (5 cm) of water in the vessel, at least a portion of the sensor is disposed below a surface of said water.

7. An apparatus according to claim 1 wherein the vessel is an elastically deformable vessel such that when the vessel is mounted with the rim oriented upward the rim is substantially deformable horizontally.

8. An apparatus according to claim 7 wherein the vessel is sufficiently structurally robust that the rim substantially resists deformation in a vertical direction.

9. An apparatus according to claim 1 wherein the valve changes state in response to a level of water in the vessel.

10. A method for providing water to a livestock animal, comprising:
providing a vessel for receiving water from a water supply via a flow valve, the vessel having an opening with a rim, a base portion, and a sidewall extending between the rim and the base portion, the sidewall defining a depth of the vessel between the rim and the base portion;
sensing the presence of the muzzle of the livestock animal in a sensing region within the vessel, the sensing region corresponding to a predetermined region within the vessel that is below a maximum fill level of the vessel; and,
supplying water from the water source into the vessel via the flow valve when the presence of the muzzle of the livestock animal is sensed within the sensing region, wherein the location of the sensing region is selected such that the livestock animal is stimulated to move its muzzle from a sensed condition to a non-sensed condition in response to rising water level approaching the maximum fill level of the vessel, and,
wherein the vessel is shaped such that the sidewall guides the livestock animal to withdraw its muzzle out of the vessel along a substantially vertical direction, such that excess water is substantially returned from the livestock animal to the vessel.

11. A method according to claim 10 comprising:
sensing that a water level within the vessel has overcome the maximum fill level; and
in response to sensing the water level overcoming the maximum fill level, inhibiting a flow of water from the water supply to the vessel via the valve.

12. A method for providing water to a livestock animal, comprising:
providing a water source for supplying water to a vessel via a flow valve;
providing a vessel for receiving water from the water source via the flow valve and for containing the received water therein;
defining a maximum fill level of the vessel; and,
disposing a sensor within the vessel at a predetermined depth below the maximum fill level of the vessel for controllably actuating the flow valve between a biased closed position absent a muzzle being sensed within the vessel and an open position when a muzzle is sensed within the vessel, the predetermined depth being selected such that the livestock animal is stimulated to move its muzzle away from the sensor in response to rising water level approaching the maximum fill level of the vessel, and
wherein the vessel is shaped such that when the livestock animal places its head into the vessel in search of water and the water level within the vessel is below the maximum fill level, the livestock animal is guided to advance its muzzle into the sensed condition.

13. A method according to claim 12 comprising:
sensing that a water level within the vessel has overcome the maximum fill level; and,
in response to sensing the water level overcoming the maximum fill level, inhibiting a flow of water from the water supply to the vessel via the valve.

14. An apparatus for providing water to a livestock animal, comprising:
a vessel for retaining water, the vessel having an opening with a rim, a base portion, and a sidewall extending between the rim and the base portion, the sidewall defining a depth of the vessel between the rim and the base portion;
a valve biased to a closed position for substantially preventing the flow of water into the vessel from a water supply line, the valve operable between the closed position and an open position for controllably dispensing water into the vessel from the water supply line; and,
a sensor disposed proximate the base section and in communication with the valve for actuating the valve between the biased closed position and the open position in response to a sensed presence of the muzzle of the livestock animal within a predetermined sensing region, the sensing region disposed within the vessel at a depth below the rim that is selected such that the livestock animal is stimulated to withdraw its muzzle away from the sensing region in response to rising water level approaching a predetermined maximum water level in the vessel,
wherein, during use, the sidewall guides the livestock animal to withdraw its muzzle out of the vessel along a substantially vertical direction, such that excess water is substantially returned from the livestock animal to the vessel.

15. An apparatus according to claim 14, wherein the sidewall is sloped away from the axis of revolution of the vessel at angle of between 2 degrees and 15 degrees.

16. An apparatus according to claim 14, wherein the sidewall defines a depth of the vessel of approximately 12 inches (30 cm).

17. An apparatus according to claim 14, wherein the valve and the sensor are provided as a same component.

18. An apparatus according to claim 17, wherein the valve is for providing water when the sensor is in physical contact with the livestock animal.

19. An apparatus according to claim 21, wherein the sensor is disposed at least 10 inches (25 cm) from the rim of the vessel.
